(19) United States
(12) Patent Application Publication
(10) Pub. No.: US 2011/0053025 A1
(43) Pub. Date: Mar. 3, 2011

(54) COOLING SYSTEM FOR FUEL CELL VEHICLE

(75) Inventors: Jaeyeon Kim, Hwaseong-si (KR); Jaesan Kim, Yongin-si (KR); Manhee Park, Suwon-si (KR)

(73) Assignees: Hyundai Motor Company, Seoul (KR); Kia Motors Corporation, Seoul (KR)

(21) Appl. No.: 12/862,500

(22) Filed: Aug. 24, 2010

(30) Foreign Application Priority Data
Aug. 31, 2009 (KR) 10-2009-0081163

(51) Int. Cl. H01M 8/04

(52) U.S. Cl. 429/435

(57) ABSTRACT

A cooling system for a fuel cell vehicle, may include a stack radiator, an electric drivetrain radiator disposed in series at a side of the stack radiator, an aircon condenser disposed in front of the stack radiator to cover the stack radiator, not the electric drivetrain radiator, and cooling fans disposed behind the stack radiator and the electric drivetrain radiator which are disposed in series.

### CROSS-REFERENCE TO RELATED APPLICATIONS

The present application claims priority to Korean Patent Application No. 10-2009-0081163 filed Aug. 31, 2009, the entire contents of which is incorporated herein for all purposes by this reference.

### BACKGROUND OF THE INVENTION

1. Field of the Invention

The present invention relates to a cooling system for a fuel cell vehicle, in detail, a technology associated with arrangement of efficient and reasonable heat-dissipating devices.

1. Description of Related Art

Fuel cell vehicles are vehicles equipped with a fuel cell generating electricity by bonding oxygen with hydrogen to use the electricity supplied from the fuel cell as power source for driving the vehicles, in which the fuel cell, unlike technologies for generating electricity in the related art, has no combustion or specific driving devices, such that it has been considered as an future-oriented environment-friendly energy supplier for vehicles with high efficiency, without causing environmental problems.

Theses fuel cell vehicles include two main heat-generating parts that need to be appropriately cooled, one of those is a stack forming the fuel cell and the other is an electric drivetrain composed of an inverter and a driving motor which drives the vehicles, using the electricity transmitted from the fuel cell.

In the fuel cell vehicles of the related art, both of the stack and the electric drivetrain are cooled by the water-cooling method for efficient and stable cooling. In general, this configuration has a stack radiator that is a heat-dissipating device for cooling the cooling water circulating around the stack and an electric drivetrain radiator that is a heat-dissipating device for cooling the cooling water circulating around the electric drivetrain, in which the radiators have different proper temperatures.

Performance of the fuel cell vehicle depends on how much the stack radiator and the electric drivetrain radiator efficiently discharge heat.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a cooling system for a fuel cell vehicle that ensures appropriate and efficient cooling performance for a stack radiator cooling a stack of the fuel cell and an electric drivetrain radiator cooling an electric drivetrain, and can be achieved by a relatively simple configuration and assembly process.

An aspect of the present invention provides a cooling system for a fuel cell vehicle including: a stack radiator, an electric drivetrain radiator disposed in series at a side of the stack radiator, an aircon condenser disposed in front of the stack radiator to cover the stack radiator, not the electric drivetrain radiator, and cooling fans disposed behind the stack radiator and the electric drivetrain radiator which are disposed in series.

Further, another aspect of the present invention provides a cooling system for a fuel cell vehicle including an integral radiator frame for arranging the stack radiator and the electric drivetrain radiator in series in one plane.

The present invention are directed provides a cooling system for a fuel cell vehicle that ensures appropriate and efficient cooling performance for a stack radiator cooling a stack of the fuel cell and an electric drivetrain radiator cooling an electric drivetrain, and can be achieved by a relatively simple configuration and assembly process.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a view showing the main part of a cooling system for a fuel cell vehicle according to an embodiment of the present invention.

FIG. 2 is a conceptual view of the configuration of FIG. 1 seen from above.

FIG. 3 is a conceptual view of the configuration of FIG. 1 seen from the right.

FIG. 4 is a view illustrating cooling of an embodiment of the present invention on the basis of the expressions of FIG. 2.

FIG. 5 is a view showing an embodiment of a radiator with one heat-dissipating core.

FIG. 6 is a view showing an embodiment of a radiator with two radiators connected in a row.

FIG. 7 is a view showing an embodiment of a radiator with two radiators connected in a series.

FIG. 8 is a perspective view showing an embodiment of an integral radiator frame.

FIG. 9 is a front view of FIG. 8.

FIG. 10 is a cross-sectional view of the portion indicated by the line A of FIG. 9.

FIG. 11 is a view showing another embodiment of the enlarged portion of FIG. 10.

FIG. 12 is a cross-sectional view taken along the line B of FIG. 9.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

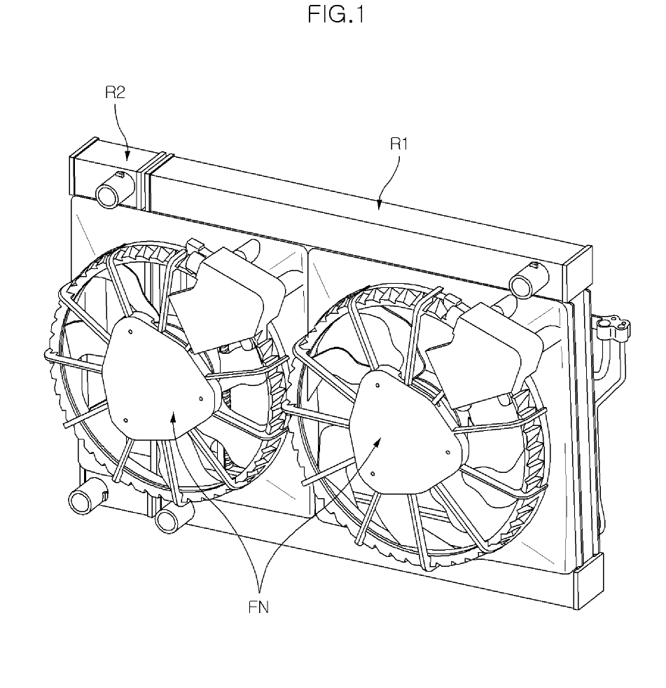

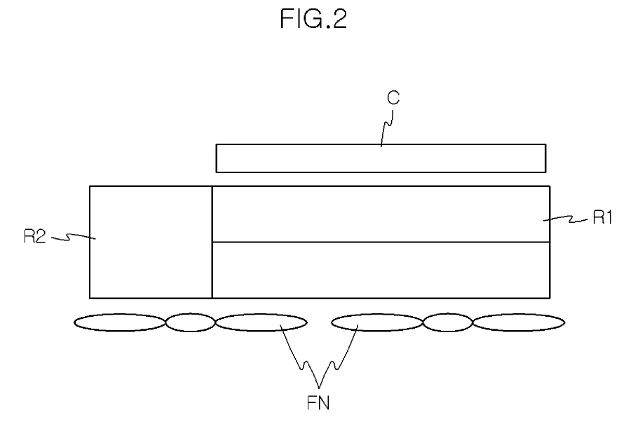

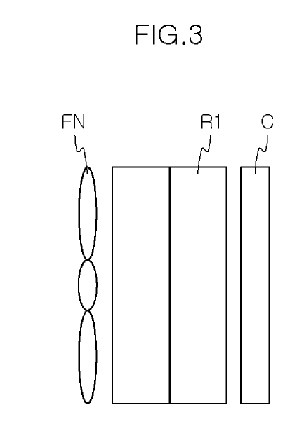

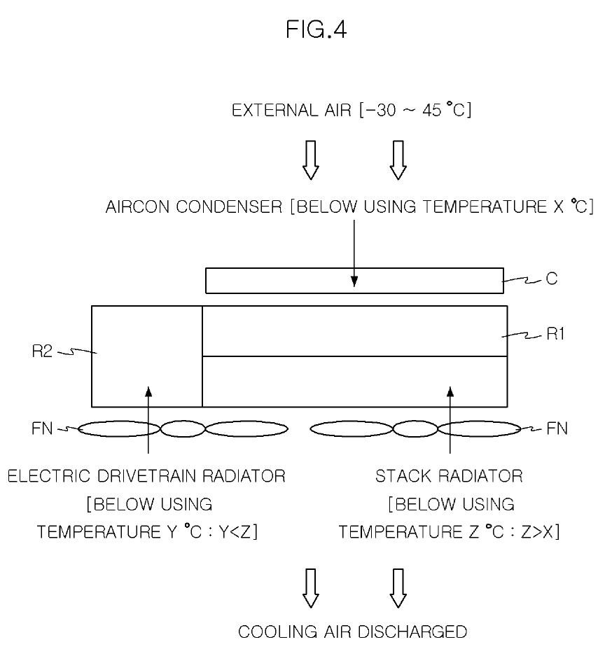

Referring to FIGS. 1 to 7, an embodiment of the present invention includes, a stack radiator R1, an electric drivetrain radiator R2 disposed in series at a side of the stack radiator, an aircon condenser C disposed in front of the stack radiator to cover stack radiator R1, not electric drivetrain radiator R2, and cooling fans FN disposed behind stack radiator R1 and electric drivetrain radiator R2 which are disposed in parallel.

That is, stack radiator R1 for dissipating to the outside the heat from the cooling water circulating around the stack to cool the stack and electric drivetrain radiator R2 for dissipating the heat from the electric drivetrain are disposed at the left and right in series in the transverse direction of the car body, and aircon condenser C is disposed to cover only stack radiator R1, such that aircon condenser C, stack radiator R1, and electric drivetrain radiator R2 are simultaneously cooled by cooling fans FN.

Since electric drivetrain radiator R2 is lower in operational temperature than stack radiator R1, the cooling air that has cooled aircon condenser C having relatively high operation temperature flows to stack radiator R1 to cool it, not electric drivetrain radiator R2. Accordingly, electric drivetrain radiator R2 is directly cooled by the external air, such that it is possible to achieve more efficient cooling. Further, stack radiator R1 has the operational temperature higher than aircon condenser C, such that it is appropriately cooled by the cooling air having cooled aircon condenser C. Therefore, it does not need to prepare a specific cooling fan and space for aircon condenser C.

According to the arrangement of stack radiator R1, electric drivetrain radiator R2, and aircon condenser C, air flow resistance is reduced, compared with when all of them overlap, such that it can be expected that the cooling efficiency is improved by increase in velocity of the cooling air.

Stack radiator R1 is formed in a flat plate shape, electric drivetrain radiator R2 is formed in a flat plate shape extending from the plane formed by stack radiator R1, and stack radiator R1 is larger in area than electric drivetrain radiator R2.

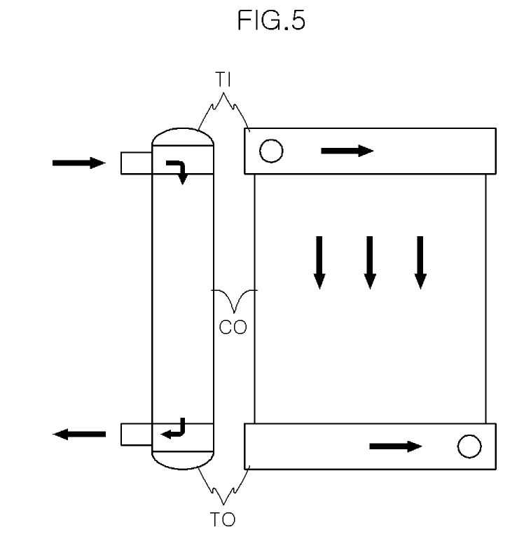

Stack radiator R1 and electric drivetrain radiator R2 may be, as in the examples shown in FIGS. 5 to 7, equipped with one heat-dissipating core CO connecting an inflow tank TI with an outflow tank TO, at least two or more overlapping heat-dissipating cores CO connecting in a row inflow tank TI with outflow tank TO in consideration the amount of heat dissipation, and at least two or more overlapping heat-dissipating cores CO connecting in a series inflow tank TI with outflow tank TO.

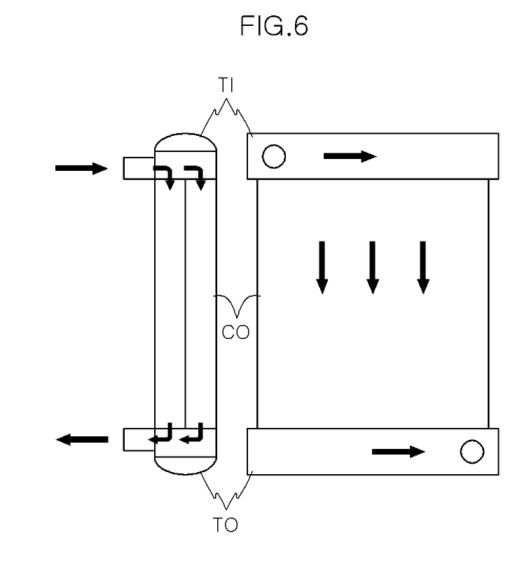

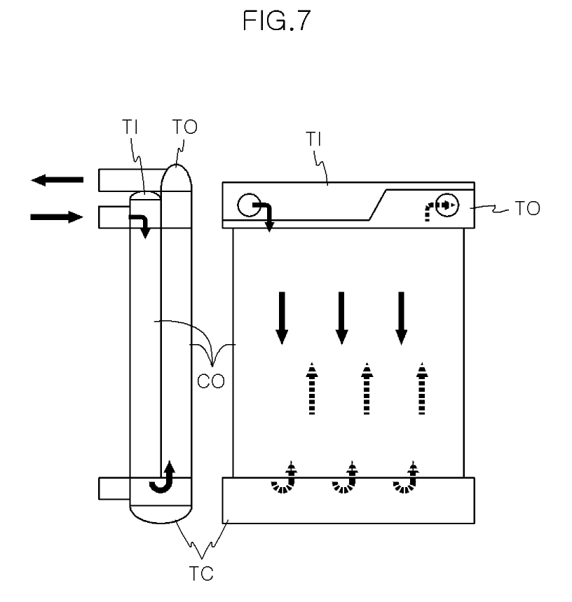

For reference, in FIGS. 5 and 6, the upper part is inflow tank TI through which the cooling water flows inside, the lower part is outflow tank TO through which the cooling water is discharged outside, and the part between inflow tank TI and outflow tank TO is heat-dissipating core CO composed of a plurality of heat-dissipating tube and heat-dissipating fins. Further, in FIG. 7, inflow tank TI and outflow tank TO are all disposed at the upper portion and a connecting tank TC connecting two heat-dissipating cores CO connecting in a series inflow tank TI with outflow tank TO is disposed at the lower portion.

Further, heat-dissipating cores CO of stack radiator R1 and electric drivetrain radiator R2, if needed, may have the same or different pitches of the heat-dissipation tubes and the heat-dissipating fins.

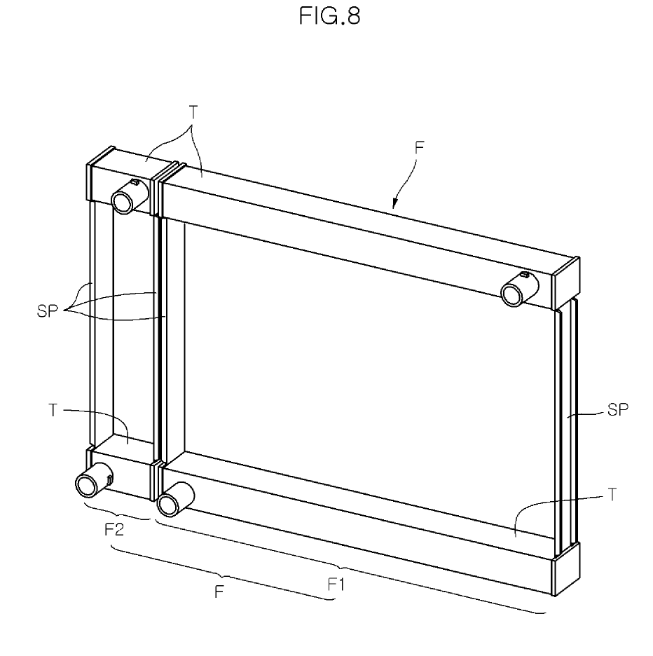

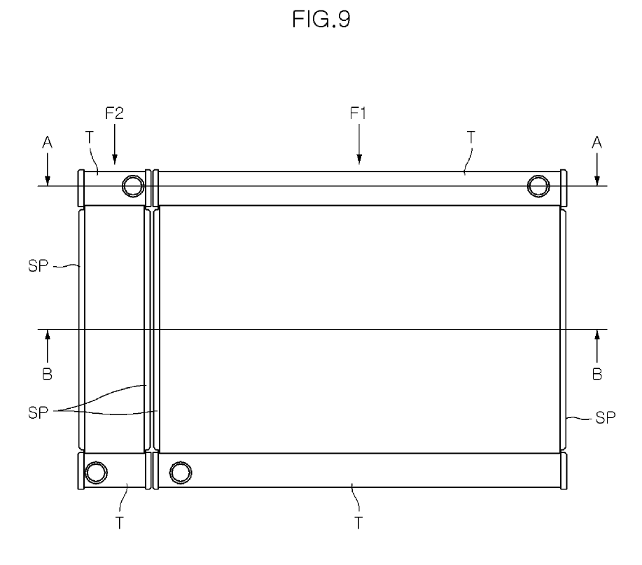

In order to achieve the cooling system for a fuel cell vehicle described above, an embodiment of the present invention includes an integral radiator frame F for arranging stack radiator R1 and electric drivetrain radiator R2 in series in a plane, as shown in FIGS. 8 to 12.

Integral radiator frame F has a stack frame F1 included in stack radiator R1 at one side and an electric drivetrain frame F2 adjacent to stack frame F1 and included in electric drivetrain radiator R2 at the other side.

Stack frame F1 and electric drivetrain frame F2 are disposed above and under heat-dissipating core CO composed of the cooling tubes and the cooling fins and have tanks T independently functioning as inflow tank TI or outflow tank TO for the cooling water, and support members SP support upper and lower tanks T.

That is, tank T implies both of inflow tank TI and outflow tank TO, in which when any one of the two upper and lower tanks is inflow tank TI, the other one functions as outflow tank TO.

On the other hand, in the embodiment shown in FIG. 7, all of inflow tank TI and outflow tank TO are disposed at the upper portion and connecting tanks TC are disposed at the lower portion, in which, strictly speaking, although connecting tank TC is slight different from the definition of tank T, it is in common in that connecting tank TC is a tank communicating with the heat-dissipating tubes to achieve the radiator. Further, it is convenient to explain connecting tank TC through common technical characteristic with inflow tank TI and outflow tank TO, in the characteristics of integral radiator frame F, which is described below. Therefore, if not specifically stated, connecting tank TC is considered as a kind of tank T.

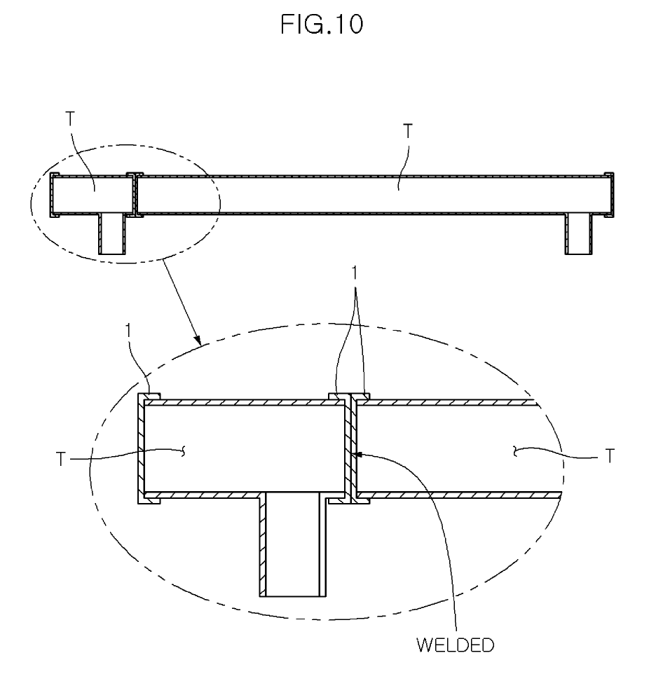

Tanks T disposed adjacent from side to side, as shown in FIG. 10, have the ends sealed with end caps 1, in which adjacent end caps 1 may be integrally connected. Further, tanks T disposed adjacent from side to side may be divided by a barrier 3 for dividing one space.

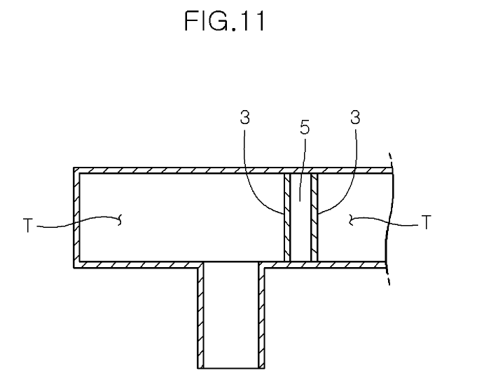

For reference, FIG. 11 shows an example when two barriers 3, which define two tanks T disposed adjacent from side to side, are disposed in parallel, with a pocket 5 therebetween.

As described above, when two tanks T are defined by two barriers 3 with pocket 5 therebetween, heat is effectively prevented from transferring between two tanks T, such that it is possible to achieve an effect of removing interference in heat-dissipating performance of the tanks.

Support members SP include a support member SP disposed between two heat-dissipating cores to separate heat-dissipating core CO of stack radiator R1 from heat-dissipating core CO of electric drivetrain radiator R2.

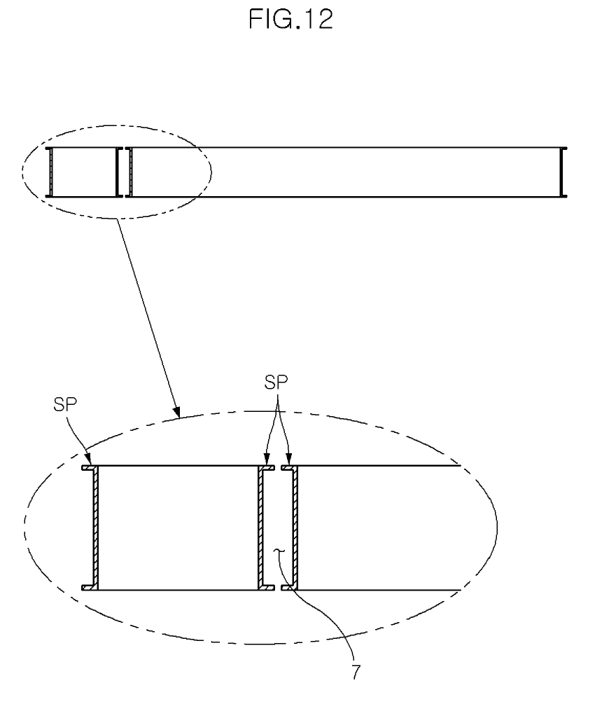

FIG. 12 shows an example including two support members SP that have U-shaped cross sections open toward adjacent opposite heat-dissipating cores CO and are disposed to face each other between two heat-dissipating cores CO such that a heat-blocking space 7 is formed between two support members SP.

Heat-blocking space 7 reduces and prevents an effect on heat-dissipating performance between them by preventing heat from transferring between two heat-dissipating cores CO.

Since integral radiator fame F having the above configuration has an integral structure, as compared with when stack radiator R1 and electric drivetrain radiator R2 are separately formed, it is possible to reduce the number of parts and manufacturing and assembling processes, and easily manipulate the frame. Therefore, it is possible to reduce the manufacturing cost and the weight.

Further, a specific assembly space is not required between the radiators, such that it is possible to increases the size of heat-dissipating cores CO, using the space, and improve the heat-dissipating performance.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the claims appended hereto and their equivalents.

What is claimed is:

1. A cooling system for a fuel cell vehicle, comprising:
a stack radiator;
an electric drivetrain radiator disposed in series at a side of the stack radiator;
an aircon condenser disposed in front of the stack radiator to cover the stack radiator, not the electric drivetrain radiator; and
cooling fans disposed behind the stack radiator and the electric drivetrain radiator which are disposed in series.

2. The cooling system for the fuel cell vehicle as defined in claim 1, wherein the stack radiator is formed in a flat plate shape;
the electric drivetrain radiator is formed in a flat plate shape extending from the plane formed by the stack radiator; and
the stack radiator is larger in area than the electric drivetrain radiator.

3. The cooling system for the fuel cell vehicle as described in claim 2, wherein the electric drivetrain radiator is disposed at the left and right in series with respect to the stack radiator in the transverse direction of a car body.

4. The cooling system for the fuel cell vehicle as described in claim 2, wherein the stack radiator and the electric drivetrain radiator are each equipped with one heat-dissipating core connecting an inflow tank with an outflow tank thereof.

5. The cooling system for the fuel cell vehicle as described in claim 4, wherein the inflow tank and the outflow tank are disposed in an upper portion of the stack radiator and the electric drivetrain radiator and a connecting tank is disposed in a lower portion thereof to fluid-connect the at least two or more heat-dissipating cores to form a fluid-passage between the inflow tank and the outflow tank.

6. The cooling system for the fuel cell vehicle as described in claim 1, wherein heat-dissipating cores of the stack radiator and the electric drivetrain radiator have substantially the same pitches of heat-dissipation tubes and heat-dissipating fins.

7. The cooling system for the fuel cell vehicle as described in claim 1, wherein heat-dissipating cores of the stack radiator and the electric drivetrain radiator have different pitches of heat-dissipation tubes and heat-dissipating fins.

8. A cooling system for a fuel cell vehicle, comprising an integral radiator frame for arranging a stack radiator and an electric drivetrain radiator in series in one plane.

9. The cooling system for the fuel cell vehicle as described in claim 8, wherein the integral radiator frame has a stack frame included in the stack radiator at one side and an electric drivetrain frame adjacent to the stack frame and included in the electric drivetrain radiator at the other side,
the stack frame and the electric drivetrain frame are disposed above and under a heat-dissipating core having cooling tubes and cooling fins and have tanks independently functioning as an inflow tank or an outflow tank, and
support members support the upper and lower tanks.

10. The cooling system for the fuel cell vehicle as described in claim 9, wherein the tanks of the stack frame and the electric drivetrain frame disposed adjacent from side to side have the ends sealed with end caps and adjacent end caps are integrally connected.

11. The cooling system for the fuel cell vehicle as described in claim 9, wherein the tanks disposed adjacent from side to side are divided by a barrier for dividing one space.

12. The cooling system for the fuel cell vehicle as described in claim 11, wherein two barriers, which define two tanks disposed adjacent from side to side, are disposed in series, with a pocket therebetween.

13. The cooling system for the fuel cell vehicle as described in claim 9, wherein the support members include a first support member disposed between two heat-dissipating cores to separate the heat-dissipating core of the stack radiator from the heat-dissipating core of the electric drivetrain radiator.

14. The cooling system for the fuel cell vehicle as described in claim 13, wherein two support members have U-shaped cross sections open toward adjacent opposite heat-dissipating cores and are disposed to face each other between two heat-dissipating cores such that a heat-blocking space is formed between the two support members.

15. The cooling system for the fuel cell vehicle as described in claim 9, wherein the stack radiator and the electric drivetrain radiator are each equipped with one heat-dissipating core connecting an inflow tank with an outflow tank.

16. The cooling system for the fuel cell vehicle as described in claim 9, wherein the stack radiator and the electric drivetrain radiator are each equipped with at least two or more heat-dissipating core connecting in parallel the inflow tank with the outflow tank.

17. The cooling system for the fuel cell vehicle as described in claim 9, wherein the stack radiator and the electric drivetrain radiator are each equipped with at least two or more heat-dissipating cores connecting in a series the inflow tank with the outflow tank.

18. The cooling system for the fuel cell vehicle as described in claim 17, wherein the inflow tank and the outflow tank are disposed in an upper portion of the stack radiator and the electric drivetrain radiator and a connecting tank is disposed in a lower portion thereof to fluid-connect the at least two or more heat-dissipating cores to form a fluid-passage between the inflow tank and the outflow tank.

19. The cooling system for the fuel cell vehicle as described in claim 9, wherein the heat-dissipating cores of the stack radiator and the electric drivetrain radiator have substantially the same pitches of heat-dissipation tubes and heat-dissipating fins.

20. The cooling system for the fuel cell vehicle as described in claim 9, wherein the heat-dissipating cores of the stack radiator and the electric drivetrain radiator have different pitches of heat-dissipation tubes and heat-dissipating fins.
